(19) United States
(12) Patent Application Publication
(10) Pub. No.: US 2015/0086065 A1
(43) Pub. Date: Mar. 26, 2015

(54) Loudspeakers With Double Dampers

(71) Applicant: Tzu-Chung Chang, Kaohsiung City (TW)

(72) Inventor: Tzu-Chung Chang, Kaohsiung City (TW)

(21) Appl. No.: 14/033,625

(22) Filed: Sep. 23, 2013

(51) Int. Cl. H04R 3/00; H04R 15/00

(52) U.S. Cl. CPC H04R 3/002; H04R 15/00
USPC 381/412

(57) ABSTRACT

A loudspeaker with double dampers include a magnetic circuit forming a magnetic field, a voice coil passing through the magnetic field of the magnetic circuit, a vibration module connected with the voice coil, a frame connected with the vibration module, and a supporting module having a pillar and first and second dampers. The pillar of the supporting module is arranged inside the voice coil and mounted on the magnetic circuit. The first damper of the supporting module is connected between the pillar and an inner surface of the voice coil, and the second damper is connected between an outer surface of the voice coil and an inner surface of the frame.

### BACKGROUND OF THE INVENTION

1. Field of the Invention

The present invention relates to a loudspeaker with double dampers and, more particularly, to a loudspeaker that are equipped with two dampers to improve the overall vibration effect thereof.

2. Description of the Related Art

A conventional structure of a loudspeaker, such as the outer magnetic loudspeaker shown in FIG. 1 and the inner magnetic loudspeaker shown in FIG. 2, usually includes a magnetic circuit 1, a gap 11, a voice coil 2, a damper 3, a vibration module 4 and a frame 5. The magnetic circuit 1 generates a steady magnetic field in the gap 11, and the voice coil 2 extends into the gap 11. If an AC current is applied to the voice coil 2, the energized voice coil 2 is driven by the magnetic field of the magnetic circuit 1 to vibrate. The vibration module 4 is connected between the voice coil 2 and the frame 5, and thus the driven voice coil 2 carries the vibration module 4 to vibrate together, so as to vibrate the air and produce sounds. The damper 3 is used to provide the required resilience of the vibration of the vibration module 4 and to maintain the axial movement of the voice coil 2. The frame 5 is mounted on the magnetic circuit 1 and protrudes from the magnetic circuit 1 in a predetermined direction.

However, with the structure shown in the FIGS. 1 and 2, the diameter of the voice coil 2 is restricted, which is unfavorable when the size of the loudspeaker is designed to be thin while the output power of the loudspeaker has to be risen. Therefore, the present invention provides a structure about a loudspeaker with double dampers to better maintain an axial movement of the voice coil, to reduce radial movement of the voice coil, to prevent the voice coil from knocking against the magnetic circuit, and to enhance the convenience in large diameter design of the voice coil for reducing the thickness of the loudspeaker with high output power.

### SUMMARY OF THE INVENTION

The primary objective of this invention is to provide a loudspeaker with double dampers, which can enhance the convenience in large diameter design of the voice coil for reducing the thickness of the loudspeaker with high output power while providing an improved vibration effect thereof.

The loudspeaker with double dampers in accordance with an aspect of the present invention includes a magnetic circuit forming a magnetic field, a voice coil passing through the magnetic field of the magnetic circuit, a vibration module connected with the voice coil, a frame connected with the vibration module, and a supporting module having a pillar and first and second dampers. The pillar of the supporting module is arranged inside the voice coil and mounted on the magnetic circuit. The first damper of the supporting module is connected between the pillar and an inner surface of the voice coil, and the second damper is connected between an outer surface of the voice coil and an inner surface of the frame.

In a form shown, the magnetic circuit is of an inner magnetic type or an outer magnetic type.

In the form shown, the loudspeaker further comprises a top post mounted on the pillar.

In the form shown, the first damper is firmly secured between the pillar and the top post.

Further scope of the applicability of the present invention will become apparent from the detailed description given hereinafter. However, it should be understood that the detailed description and specific examples, while indicating preferable embodiments of the invention, are given by way of illustration only, since variances will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a cross-sectional view of a conventional outer magnetic loudspeaker.

FIG. 2 is a cross-sectional view of a conventional inner magnetic loudspeaker.

FIG. 3 is a cross-sectional view of an outer magnetic loudspeaker with double dampers in accordance with a first embodiment of the present invention.

FIG. 4 is a cross-sectional view of an inner magnetic loudspeaker with double dampers in accordance with a second embodiment of the present invention.

FIG. 5 is a cross-sectional view of an outer magnetic loudspeaker with double dampers in accordance with a third embodiment of the present invention.

FIG. 6 is a cross-sectional view of an inner magnetic loudspeaker with double dampers in accordance with a fourth embodiment of the present invention.

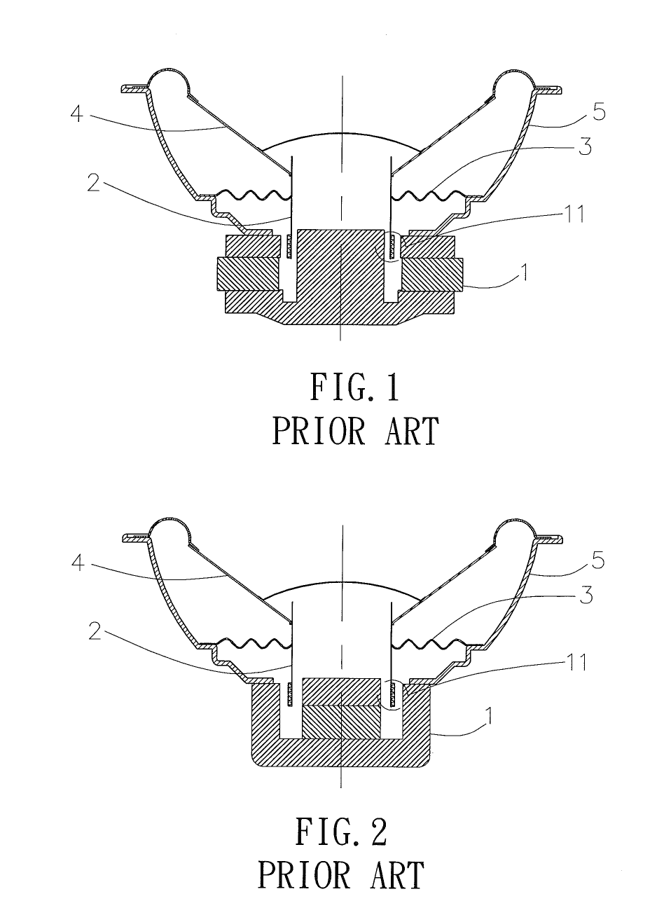

In the various figures of the drawings, the same numerals designate the same or similar parts. Furthermore, when the term “inner,” “outer,” “first,” “second,” “third,” “fourth,” “fifth,” “sixth,” “seventh,” “eighth,” “top,” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

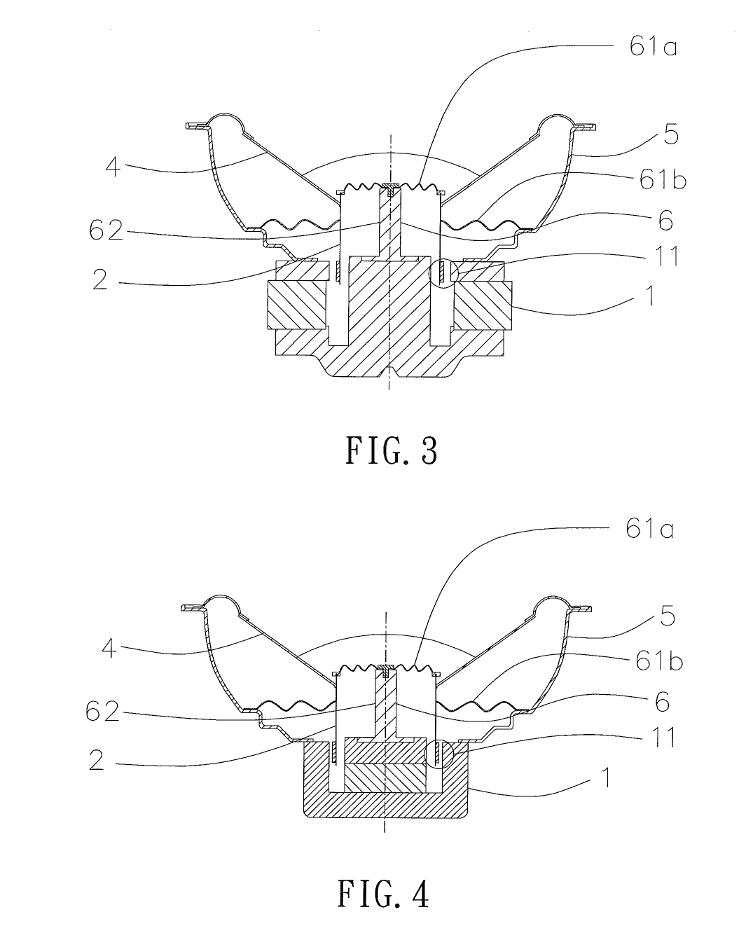

Referring to FIG. 3, in accordance with a first embodiment of the present invention, an outer magnetic loudspeaker is shown, which includes a magnetic circuit 1 having a gap 11, a voice coil 2, a vibration module 4, a frame 5, and a supporting module 6 including a first damper 61a, a second damper 61b and a pillar 62.

The frame 5 is mounted on the magnetic circuit 1 and the voice coil 2 extends into the gap 11 of the magnetic circuit 1. When an AC current is applied to the voice coil 2, the voice coil 2 is driven by a magnetic field provided by the magnetic circuit 1 to vibrate. The vibration module 4 is connected between the voice coil 2 and the frame 5, and thus the driven voice coil 2 carries the vibration module 4 to vibrate together, so as to vibrate the air and produce sounds. Besides, the magnetic circuit 1 shown in FIG. 3 is outer magnetic type, which is used to form an outer magnetic loudspeaker.

The pillar 62 of the supporting module 6 is mounted on the middle part of the top of the magnetic circuit 1. In this regard, a center of the first damper 61a is coupled with the pillar 62 while an outer periphery of the first damper 61a is coupled with an inner surface of the voice coil 2, and a center of the second damper 61b is coupled with an outer surface of the voice coil 2 while an outer periphery of the second damper 61b is coupled with an inner surface of the frame 5. The first damper 61 a arranged inside the voice coil 2 not only can provide the required resilience of the vibration module 4 and reduce radial movement of the voice coil 2 to prevent the voice coil 2 from knocking against the magnetic circuit 1, but also can enhance the convenience in large diameter design of the voice coil 2 for reducing the thickness of the loudspeaker with high output power. In this embodiment, the outer magnetic loudspeaker employs two dampers 61a and 61b, one of which is arranged inside the voice coil 2 and the other one is arranged outside of the voice coil 2. In this regard, the two dampers 61a and 61b are located at two sides of the vibration module 4 in the radial direction and are used to fix the voice coil 2 and the vibration module 4. Advantageously, the strength of the radial vibration of the vibration module 4 can be enhanced and the radial vibration of said system 4 can be balanced. Furthermore, since the two dampers 61a and 61b are located at two sides of the vibration module 4 in the radial direction, a suspension system having an improved Kms is formed. The term “Kms” is a common mechanical unit and is a reciprocal of Cms. “Kms” varies as the voice coil 2 moves. The suspension system is considered as a linear system when the Kms values of the suspension system moving in two opposite directions are equal, namely, Kms(−X)=Kms(X). In this case, the suspension system has an improved Kms symmetry.

Referring to FIG. 4, in accordance with a second embodiment of the present invention, an inner magnetic loudspeaker is shown, which has similar structure and operation of those of the first embodiment, but a magnetic circuit 1 of an inner magnetic type is used.

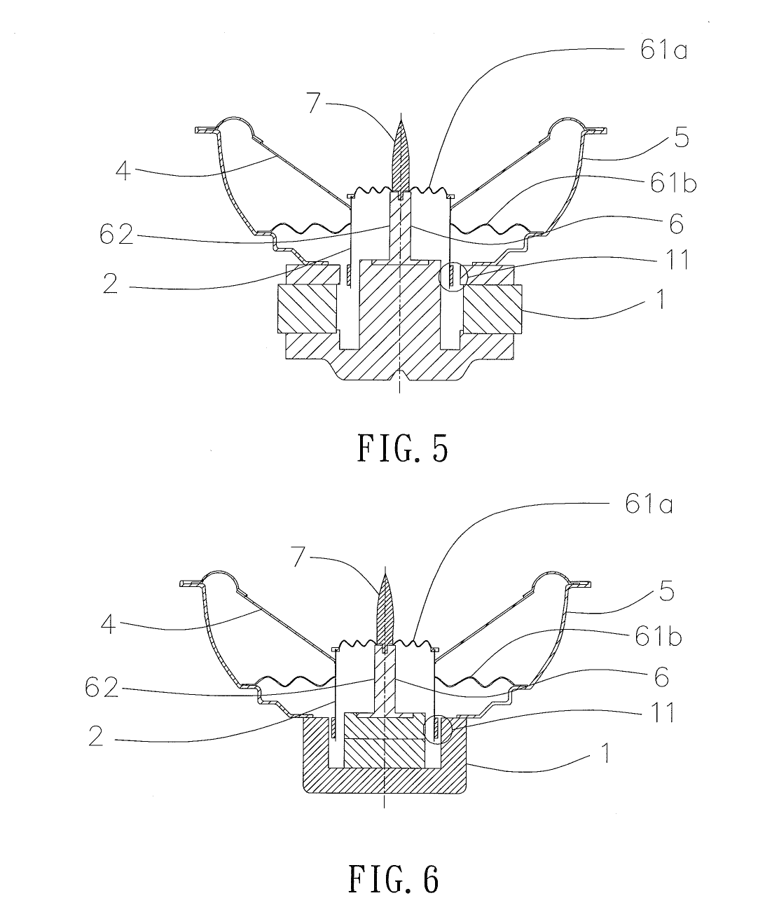

Referring to FIG. 5, in accordance with a third embodiment of the present invention, an outer magnetic loudspeaker is shown, which has similar structure and operation of those of the first embodiment, but a top post 7 is mounted on the pillar 62. The top post 7 helps to secure the first damper 61a in order to improve the vibration of the outer magnetic loudspeaker. The first damper 61a may be firmly sandwiched between pillar 62 and the top post 7.

Referring to FIG. 6, in accordance with a fourth embodiment of the present invention, an inner magnetic loudspeaker is shown, which has similar structure and operation of those of the second embodiment, but a top post 7 is mounted on the pillar 62. The top post 7 helps to secure the first damper 61a in order to improve the vibration of the outer magnetic loudspeaker. The first damper 61a may be firmly sandwiched between pillar 62 and the top post 7.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A loudspeaker with double dampers comprising:
a magnetic circuit forming a magnetic field;
a voice coil passing through the magnetic field of the magnetic circuit;
a vibration module connected with the voice coil;
a frame connected with the vibration module; and
a supporting module having a pillar and first and second dampers,
wherein the pillar of the supporting module is arranged inside the voice coil and mounted on the magnetic circuit, wherein the first damper of the supporting module is connected between the pillar and an inner surface of the voice coil, and wherein the second damper is connected between an outer surface of the voice coil and an inner surface of the frame.

2. The loudspeaker with double dampers as defined in claim 1, wherein the magnetic circuit is of an inner magnetic type.

3. The loudspeaker with double dampers as defined in claim 1, wherein the magnetic circuit is of an outer magnetic type.

4. The loudspeaker with double dampers as defined in claim 1, further comprising a top post mounted on the pillar.

5. The loudspeaker with double dampers as defined in claim 1, wherein the first damper is firmly secured between the pillar and the top post.
